(19) United States
(12) Patent Application Publication
(10) Pub. No.: US 2022/0305567 A1
(43) Pub. Date: Sep. 29, 2022

(54) Repair Tool And Method

(71) Applicant: William B. Dannehl, York, PA (US)

(72) Inventor: William B. Dannehl, York, PA (US)

(21) Appl. No.: 17/212,534

(22) Filed: Mar. 25, 2021

(51) Int. Cl. B23B 27/16; E04G 23/02

(52) U.S. Cl. CPC B23B 27/16; E04G 23/0207

(57) ABSTRACT

A wall repair tool includes a cutter rotatable about a cutter axis and having a cutter body with a cutting surface. The cutter body has a central section and a pair of end sections disposed on opposite sides of the central section. The cutting surface has a first cutting texture in the central section and a second cutting texture different than the first cutting texture in the end sections.

### FIELD OF THE INVENTION

The present invention relates to a repair tool and, more particularly, to a repair tool and a method of using the repair tool to repair a hole in a wall.

BACKGROUND

Interior surfaces of structures can suffer damage over time, such as cuts, divots, or holes in the walls. Typically, to repair the damage, an opening is cut through the wall around the area to be repaired and a repair piece of wall material is secured in the opening. Seams that need to be covered are formed at joints between the existing wall and the repair piece of wall material.

A joint 100 of a typical wall repair is shown in FIG. 1. An existing wall 110 and a repair piece 120 abut one another at a seam 130 of the joint 100. To cover the seam 130, a piece of joint tape 140 is adhered onto an outer surface 112 of the existing wall 110 and an outer surface 122 of the repair piece 120 over the seam 130. A joint compound 150 is then applied onto the outer surface 112 of the existing wall 110 and the outer surface 122 of the repair piece 120 to cover the joint tape 140 and the seam 130.

As shown in FIG. 1, the joint compound 150 applied directly to the outer surface 112 of the existing wall 110 and the outer surface 122 of the repair piece 120 is thickest over the seam 130 and must be spread out over a large area, often over 1 ft beyond the seam 130 on each side, in order to provide a smooth finish for the repair over the outer surfaces 112, 122. Applying the joint compound 150 over such a large area requires a significant amount of joint compound 150 that is costly, is time consuming to apply, takes a long time to dry, and can lead to aesthetically displeasing inconsistencies in the evenness of the repaired wall.

### SUMMARY

A wall repair tool includes a cutter rotatable about a cutter axis and having a cutter body with a cutting surface. The cutter body has a central section and a pair of end sections disposed on opposite sides of the central section. The cutting surface has a first cutting texture in the central section and a second cutting texture different than the first cutting texture in the end sections.

### BRIEF DESCRIPTION OF THE DRAWINGS

The invention will now be described by way of example with reference to the accompanying Figures, of which:

FIG. 1 is a sectional side view of a joint of a typical wall repair;

FIG. 2 is a sectional side view of a wall repair tool according to an embodiment;

FIG. 3 is a side view of a cutter of the wall repair tool;

FIG. 4 is a side view of the wall repair tool with a housing removed;

FIG. 5 is a flowchart of a process of using the wall repair tool to repair an existing portion of a wall;

FIG. 6A is a sectional perspective view of an existing portion of a wall with a support assembly;

FIG. 6B is a sectional side view of a portion of FIG. 6A;

FIG. 7A is a sectional perspective view of the existing portion of the wall with the support assembly and a repair section;

FIG. 7B is a sectional side view of a portion of FIG. 7A; and

FIG. 8 is a sectional side view of a joint according to an embodiment.

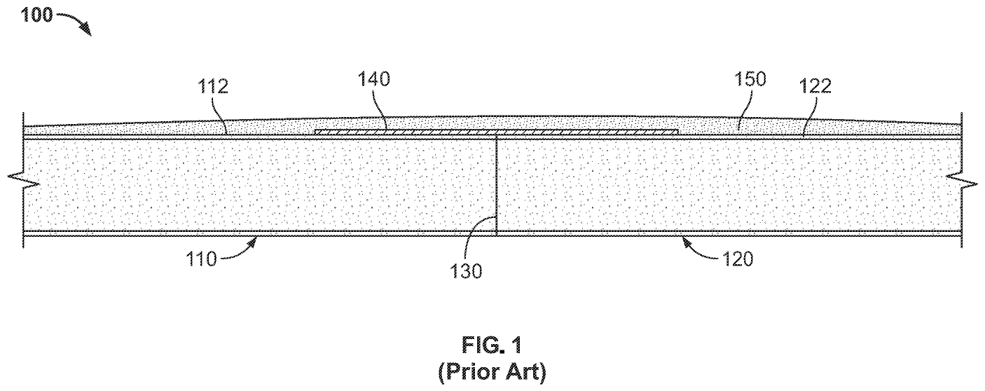

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth in order to provide a thorough understanding of the disclosed embodiments. However, it is apparent that one or more embodiments may also be implemented without these specific details.

The term “wall” is used throughout the specification to refer both to material forming the vertical portions of interior spaces, the elements commonly referred to as walls, and also to material forming the ceiling of the interior spaces. As the materials of the “walls” described below are commonly used both for interior wall surfaces and ceiling surfaces in many structures, the term “wall” herein is intended to broadly encompass both wall surfaces and ceiling surfaces.

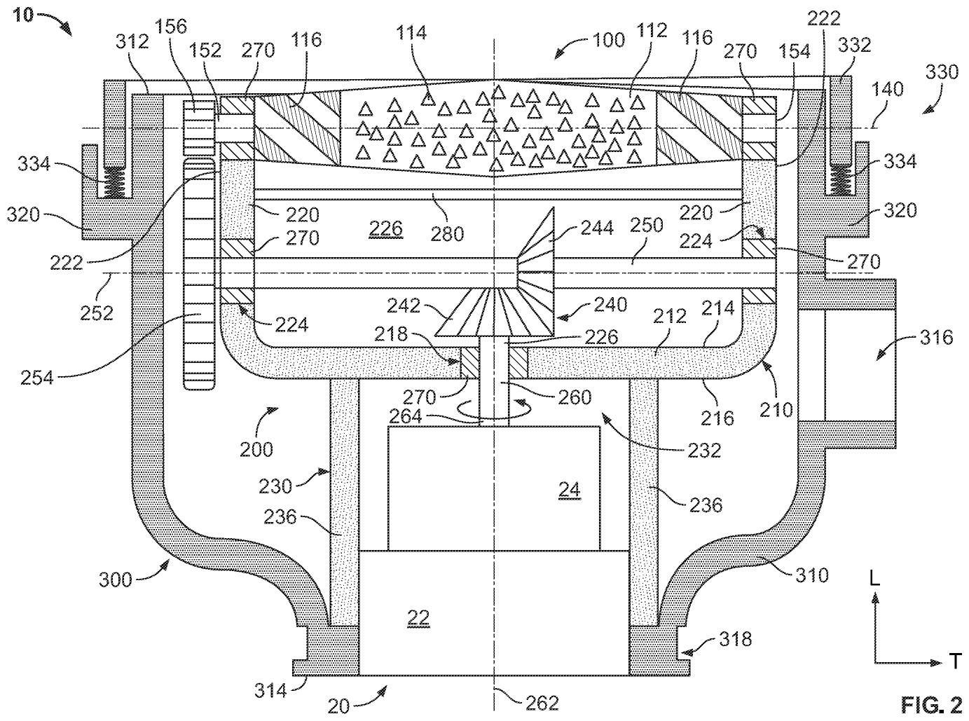

A wall repair tool 10 according to an embodiment, as shown in FIG. 2, comprises a cutter 100, a drive adapter 200 connected to the cutter 100, and a housing 300 disposed around the cutter 100 and the drive adapter 200.

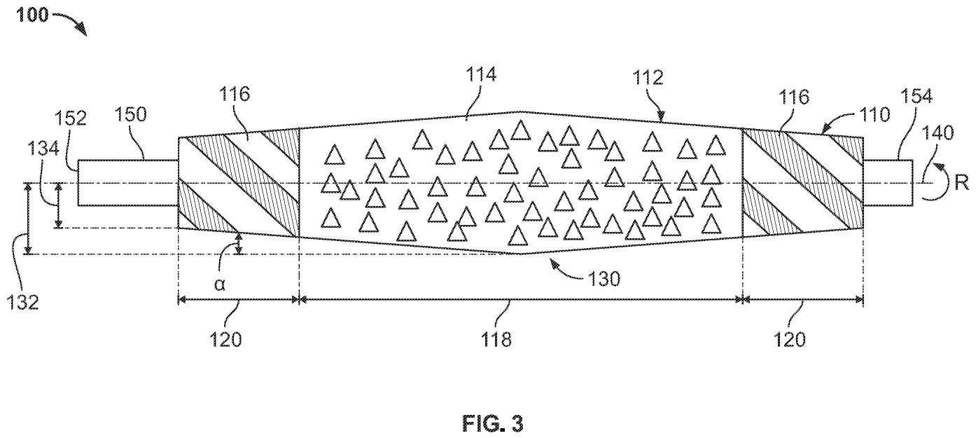

The cutter 100, as shown in FIG. 3, has a cutter body 110 extending along a cutter axis 140. The cutter 100 is rotatable about the cutter axis 140 along a rotational direction R. The cutter body 110 has a cutting surface 112 forming an entire outer surface of the cutter body 110. The cutter body 110 has a central section 118 and a pair of end sections 120 disposed adjacent to the central section 118 and on opposite sides of the central section 118 along the cutter axis 140. The central section 118 is disposed between the end sections 120 along the cutter axis 140.

The cutting surface 112, as shown in FIG. 3, is positioned in the central section 118 and the end sections 120. The cutting surface 112 has a first cutting texture 114 in the central section 118 and a second cutting texture 116 in the end sections 120. The cutting textures 114, 116 are each an array of sharp, shaped, rigid elements formed on or by the cutting surface 112 that are capable of cutting various types of material when in contact with the material while the cutter 100 is rotated. The first cutting texture 114 is different from the second cutting texture 116. In the embodiment shown in FIGS. 2 and 3, the first cutting texture 114 is a rasp cutting texture, for example, a densely arranged series of sharp protrusions that could be in number of different structural forms. In the embodiment shown in FIGS. 2 and 3, the second cutting texture 116 is a fluted cutting texture, for example, comparable to the fluting of a drill bit. In other embodiments, the first cutting texture 114 and the second cutting texture 116 could be any other type of arrays of sharp, shaped, rigid elements that are capable of removing material when rotated. The selection of the particular first cutting texture 114 and second cutting texture 116 will depend on the type of material that is being removed by the cutter 100, as described in greater detail below.

The cutter body 110, as shown in FIG. 3, has a tapered profile 130 along the cutter axis 140. The tapered profile 130 has a maximum radius 132 centrally along the cutter axis 140; in a center of the center section 118. The tapered profile 130 has a minimum radius 134 in the end sections 120 at a pair of opposite ends of the cutter body 110 along the cutter axis 140 distal from the maximum radius 132. In the embodiment shown in FIGS. 2 and 3, the cutting surface 112 extends linearly from the maximum radius 132 to the minimum radius 134, at a taper angle α with respect to a direction extending from the maximum radius 132 parallel to the cutter axis 140. The taper angle α is an acute angle. In various embodiments, the minimum radius 134, the maximum radius 132, and the taper angle α vary based on the application and depth requirements of a cut made using the cutter 100, as described in detail below. In other embodiments, the cutting surface 112 could extend in a curved manner from the maximum radius 132 to the minimum radius 134.

As shown in FIGS. 2 and 3, the cutter body 110 is positioned on a cutter shaft 150, which extends centrally through the cutter body 110 along the cutter axis 140 from a first end 152 to a second end 154. In shown embodiment, the first end 152 of the cutter shaft 150 is positioned further from an adjacent one of the end sections 120 along the cutter axis 140 than a distance along the cutter axis 140 between the second end 154 and the other of the end sections 120. As shown in FIG. 2, a cutter gear 156 is positioned on the first end 152 and, in the shown embodiment, the cutter gear 156 is positioned a distance from the adjacent one of the end sections 120 along the cutter axis 140.

The cutter 100, including the cutter body 110 with the cutting surface 112 and the cutter shaft 150, is formed of a metal material in an embodiment. In other embodiments, the cutter 100 could be formed of a rigid plastic material, or any other material with sufficient rigidity and hardness to perform the cutting functions described in detail below. In various embodiments, the cutter 100 can be monolithically formed in a single piece from the elements described herein, or can be fabricated as a plurality of separate pieces and assembled together.

The drive adapter 200, as shown in FIG. 2, includes a frame 210, a bevel gear set 240 disposed within the frame 210, a main drive shaft 250 held by the frame 210, and a device drive shaft 260 held by the frame 210.

The frame 210, as shown in FIG. 2, has a base 212 with a first base side 214 and a second base side 216 opposite to the first base side 214 in a longitudinal direction L. The base 212 has a first shaft opening 218 extending through the base 212 along the longitudinal direction L. The frame 210 has a pair of arms 220 extending from the first base side 214 and a collar 230 extending from the second base side 216.

The pair of arms 220, as shown in FIG. 2, extend from the first base side 214 and form an approximate U-shape with the base 212. The base 212 and the arms 220 define a gear receiving space 226. The pair of arms 220 each have a retention end 222 at an end opposite the first base side 214. Each of the arms 220 has a second shaft opening 224 extending through the arm 220 in a transverse direction T perpendicular to the longitudinal direction L.

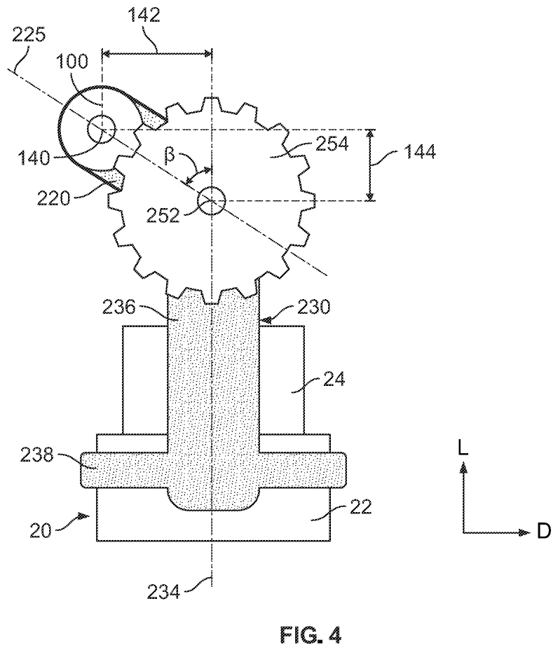

The arms 220, as shown in FIG. 4, extend at an arm angle β with respect to the collar 230. The arm angle β is formed between a centerline 234 extending centrally through the collar 230 and a centerline 225 extending centrally along the arms 220. The arms 220 extend from the base 212 in the longitudinal direction L and in a depth direction D perpendicular to the longitudinal direction L. The centerline 234 of the collar 230 is parallel to the longitudinal direction L and the centerline 225 of the arms 220 extends in a plane defined by the depth direction D and the longitudinal direction L. The arm angle β is an acute angle.

The collar 230, as shown in FIG. 2, has a pair of parallel portions 236 extending from the second base side 216 along the longitudinal direction L. As shown in FIG. 4, the collar 230 has a band 238 connecting the parallel portions 236 adjacent an end of the parallel portions 236 opposite the second base side 216; the band 238 forms an enclosed shape in a plane defined by the depth direction D and the transverse direction T. The collar 230 defines a rotational input device receiving space 232 between the parallel portions 236 and the band 238.

The bevel gear set 240, as shown in FIG. 2, includes a first bevel gear 242 and a second bevel gear 244 meshed with the first bevel gear 242. The second bevel gear 244 is disposed perpendicular to the first bevel gear 242, and rotation of the first bevel gear 242 about the longitudinal direction L imparts rotation to the second bevel gear 244 about the transverse direction T.

The main drive shaft 250, as shown in FIG. 2, is a rod around which the second bevel gear 244 is fixed. The main drive shaft 250 has a pair of opposite ends positioned in the second shaft openings 224 of each of the arms 220 and extends between the arms 220 along the transverse direction T. The second bevel gear 244 around the main drive shaft 250 is positioned in the gear receiving space 226. In the shown embodiment, the ends of the main drive shaft 250 are each positioned in a bushing 270 that is disposed in one of the second shaft openings 224. The main drive shaft 250 is rotatable within the bushings 270 and with respect to the arms 220 around a main drive shaft axis 252 that extends parallel to the transverse direction T. A drive gear 254 attached to an end of the main drive shaft 250 and rotatable with the main drive shaft 250 about the main drive shaft axis 252 is disposed outside of the frame 210, on a side of one of the arms 220 opposite the gear receiving space 226 in the transverse direction T.

The device drive shaft 260, as shown in FIG. 2, is a rod having an input end 264 and a gear end 266 opposite the input end 264 along the longitudinal direction L. The device drive shaft 260 extends through the first shaft opening 218 of the base 212, with the input end 264 disposed in the rotational input device receiving space 232 and the gear end 266 disposed in the gear receiving space 226. In the shown embodiment, the device drive shaft 260 is positioned in a bushing 270 that is disposed in the first shaft opening 218. The device drive shaft 260 is rotatable within the bushing 270 and with respect to the base 212 about a device drive shaft axis 262 that extends along the longitudinal direction L. The input end 264 is capable of receiving a rotational input device 20, as described in greater detail below. The gear end 266 is fixed to the first bevel gear 242.

In the embodiment shown in FIG. 2, the drive adapter 200 has a gear shield 280 disposed within the gear receiving space 226. The gear shield 280 extends between the arms 220 along the transverse direction T and separates a portion of the gear receiving space 226 containing the bevel gear set 240 from a remainder of the gear receiving space 226 along the longitudinal direction L.

The housing 300, as shown in FIG. 2, has a housing body 310 and a guard assembly 330 attached to the housing body 310.

The housing body 310, as shown in FIG. 2, extends from a cutting end 312 to an attachment end 314 along the longitudinal direction L. The housing body 310 has a port 316 extending through the housing body 310 in the transverse direction T between the cutting end and the attachment end 314. The housing body 310 has a retention groove 318 extending into the housing body 310 at the attachment end 314 and, in an embodiment, extending circumferentially around the housing body 310. A guard stop 320 of the housing body 310 is disposed adjacent to the cutting end 312 and protrudes outward from the housing body 310. In the shown embodiment, the guard stop 320 is formed in an L-shape. In other embodiments, the guard stop 320 can be formed in any shape that is capable of forming a stop for the guard assembly 330 as described below.

As shown in FIG. 2, the guard assembly 330 has a cutter guard 332 and a guard spring 334. The cutter guard 332 is disposed around the cutting end 312 of the housing body 310. The guard spring 334 is held between the cutter guard 332 and the guard stop 320 of the housing body 310. The cutter guard 332 is biased by the guard spring 334 into a position in which the cutter guard 332 extends beyond the cutting end 312 along the longitudinal direction L and covers the cutting end 312. The cutter guard 332, as described in further detail below, is movable and can be compressed against the guard spring 334 to be positioned below the cutting end 312 along the longitudinal direction L, exposing the cutting end 312.

The assembly of the cutter 100, the drive adapter 200, and the housing 300 to form the wall repair tool 10 will now be described primarily with reference to FIG. 2.

As shown in FIGS. 2 and 4, the cutter 100 is held in the gear receiving space 226 at the retention end 222 of each of the arms 220. In the shown embodiment, the first end 152 and the second end 154 of the cutter shaft 150 are each held in a bushing 270 at the retention end 222 of one of the arms 220. The cutter 100 is rotatable within the bushings 270 and with respect to the arms 220 and the frame 210 about the cutter axis 140.

The cutter gear 156 is disposed outside of the frame 210 and on a side of one of the arms 220 opposite the cutter 100, as shown in FIG. 2. The cutter gear 156 is meshed with the drive gear 254; rotation of the main drive shaft 250 about the main drive shaft axis 252 rotates the cutter 100 about the cutter axis 140. As shown in FIG. 4, due to the arm angle β, the cutter axis 140 has a depth offset 142 from the main drive shaft 250 in the depth direction D and has a longitudinal offset 144 from the main drive shaft 250 in the longitudinal direction L.

The housing body 310 of the housing 300, as shown in FIG. 2, is disposed around and covers the cutter 100 and the drive adapter 200. The cutter 100 is positioned at the cutting end 312 of the housing 300 and, in all rotational positions of the cutter 100 about the cutter axis 140, a portion of the cutting surface 112 in the central section 118 and in the end sections 120 protrudes beyond the cutting end 312 of the housing body 310. When the cutter guard 332 is fully biased by the guard spring 334 away from the guard stop 320, the portion of the cutting surface 112 protruding beyond the cutting end 312 is covered by the cutter guard 332. When the cutter guard 332 is moved against the bias of the guard spring 334, the cutter guard 332 can expose the portion of the cutting surface 112 protruding beyond the cutting end 312.

The wall repair tool 10 is capable of being used with a rotational input device 20, as shown in FIGS. 2 and 4.

The rotational input device 20, as shown in FIG. 2, has a device body 22 and a chuck 24 connected to the device body 22. The chuck 24 is driven to rotate with respect to the device body 22 when the rotational input device 20 is actuated. The chuck 24, in various embodiment, has a bit protruding from the chuck 24 and rotatable with the chuck 24 or is capable of releasably receiving a bit protruding from and rotatable with the chuck 24. In an embodiment, the rotational input device 20 is an electric drill, such as the type commonly available and widely owned. In another embodiment, the rotational input device 20 is a drywall router. In other embodiments, the rotational input device 20 may be any other device capable of releasably attaching to the wall repair tool 10 and driving rotation of the wall repair tool 10 as described below.

As shown in FIGS. 2 and 4, the rotational input device 20 is inserted along the longitudinal direction L into the wall repair tool 10. The rotational input device 20 is inserted into the rotational input device receiving space 232 until the chuck 24 engages the input end 264 of the device drive shaft 260. In the shown embodiment, the parallel portions 236 and the attachment end 314 of the housing body 310 abut the device body 22. The retention groove 318 extends around the device body 22 at the abutment of the device body 22 with the attachment end 314. In an embodiment, a clamp can be disposed in the retention groove 318 to releasably secure the rotational input device 20 in the rotational input device receiving space 232 in the position shown in FIG. 2. In other embodiments, elements other than the retention groove 318 and the clamp may be used to releasably secure the rotational input device 20 in the rotational input device receiving space 232.

The rotational input device 20 drives rotation of the cutter 100 via the drive adapter 200, as shown in FIG. 2. When the rotational input device 20 is actuated by a user, the chuck 24 is driven to rotate with respect to the device body 22. Rotation of the chuck 24 drives rotation of the device drive shaft 260 around the device drive shaft axis 262, which correspondingly rotates the first bevel gear 242. Rotation of the first bevel gear 242 about the device drive shaft axis 262 rotates the second bevel gear 244 meshed with the first bevel gear 242, rotating the main drive shaft 250 about the main drive shaft axis 252 perpendicular to the device drive shaft axis 262. The rotation of the main drive shaft 250 correspondingly rotates the drive gear 254 about the main drive shaft axis 252, which rotates the cutter gear 156 meshed with the drive gear 254 about the cutter axis 140. Rotation of the cutter gear 156 about the cutter axis 140 rotates the cutter 100 about the cutter axis 140.

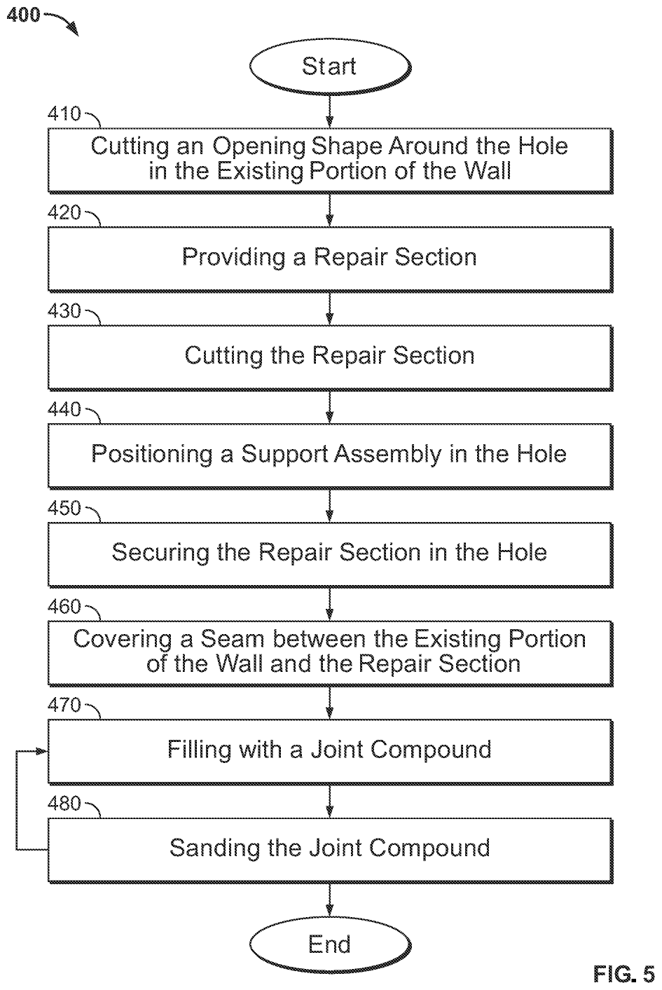

A repairing method or process 400 of using the wall repair tool 10 to repair an existing portion of a wall 30 having a hole 32 will now be described primarily with respect to FIGS. 5-8.

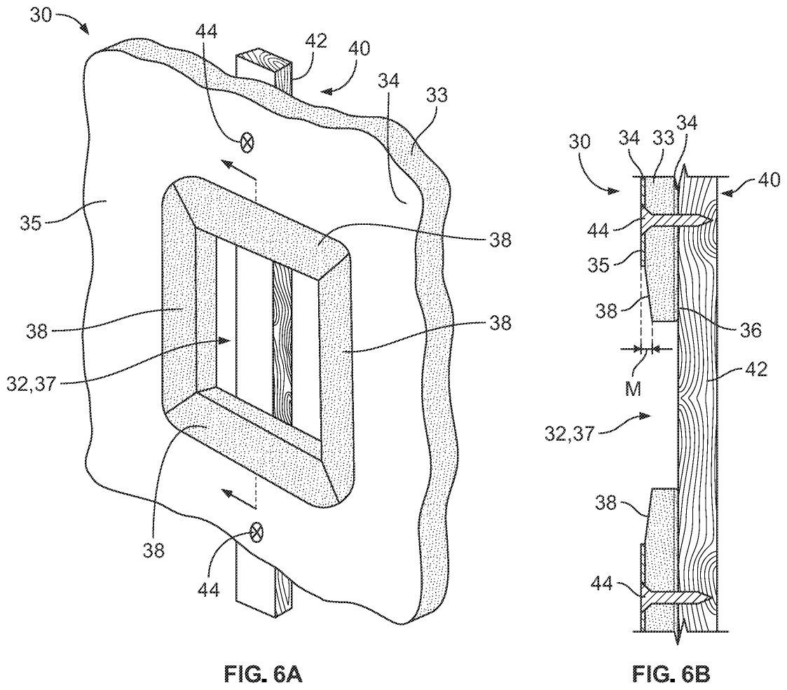

The existing portion of the wall 30 with the hole 32 is shown in FIG. 6A. In the embodiment shown in FIGS. 6A-8, the existing portion of the wall 30 is a piece of drywall having, as shown for example in FIG. 6B, a wall body 33 and a pair of layers 34 disposed on opposite sides of the wall body 33. In an embodiment, the wall body 33 includes a gypsum material and the layers 34 are each made of a paper material. In other embodiments of the existing portion of the wall 30 embodied as drywall, the wall body 33 and the layers 34 can be formed of any types of material used in drywall. In other embodiments, the existing portion of the wall 30 is not formed of drywall and may be constituted only by the wall body 33, omitting the layers 34; in these embodiments, the wall 30 can be formed of a plaster material, a gypsum material, or any other type of material commonly used to form interior walls.

In all embodiments, the wall 30 has an outer surface 35 and an inner surface 36 opposite the outer surface 35. The hole 32 extends through the wall 30 from the outer surface 35 to the inner surface 36, as shown in FIGS. 6A and 6B. The hole 32 has an opening shape 37. The opening shape 37 is a square in the shown embodiment, but can be any other type of regular, straight-sided or curved shape in other embodiments. In an initial state, the hole 32 extending through the wall 30 may have an irregular, ragged contour as a result, for example, of an object puncturing or otherwise contacting the wall 30; the opening shape 37 may be formed by initial preparation and trimming of the wall 30 around the hole 32.

The repairing method 400 begins in a step 410 shown in FIG. 5 by using the wall repair tool 10 to cut around the opening shape 37 of the hole 32 in the existing portion of the wall 30. The process of using the wall repair tool 10 to cut an element will now be described in detail; the same description applies in each instance of using the wall repair tool 10 to cut and, for clarity of the description, will not be repeated each time.

With the wall repair tool 10 assembled as shown in FIG. 2 and with the rotational input device 20 inserted into the rotational input device receiving space 232 as described above, the user activates the rotational input device 20 to rotate the cutter 100 about the cutter axis 140. The user moves the wall repair tool 10 with the rotating cutter 100 toward the element to be cut, the wall 30 in the step 410, until the cutter guard 332 contacts the outer surface 35 of the wall 30. As the user continues to press the wall repair tool 10 toward the wall 30, the cutter guard 332 is pressed against the bias of the guard spring 334 toward the guard stop 320. The movement of the cutter guard 332 toward the guard stop 320 exposes the cutter 100 and allows the rotating cutter 100 to contact the outer surface 35 of the wall 30.

In the step 410, the maximum radius 132 of the cutter body 110 is aligned with the edge of the wall 30 adjacent to the hole 32. In this position, half of the cutting surface 112 and one of the end sections 120 is in contact with the outer surface 35 of the wall 30 while the cutter 100 is driven to rotate. The rotation of the cutter 100 and the contact of the first cutting texture 114 and the second cutting texture 116 with wall body 33, and in an embodiment the layers 34, abrades and removes the material of the wall body 33 and the layers 34 during rotation. In the shown embodiment, the rasp cutting texture of the first cutting texture 114 is adapted to efficiently remove the gypsum material of the wall body 33 and the fluted cutting texture of the second cutting texture 116 is adapted to cleanly sever and remove the paper of the layers 34. In other embodiments, the first cutting texture 114 and the second cutting texture 116 could be formed differently to remove other types of material of the wall body 33 and, in some embodiments, the layers 34.

The debris of the wall body 33 and the layers 34 removed by the rotating cutter 100 is protected from reaching the bevel gear set 240 and other elements disposed in the gear receiving space 226 by the gear shield 280 shown in FIG. 2. In the embodiment shown in FIG. 2, a vacuum or other suction device can be attached to the port 316 and any debris of the wall body 33 and the layers 34 that is disposed within the housing body 310 can be removed through the port 316.

The rotating cutter 100 is pressed deeper into the wall 30 until an outermost edge of the end section 120 contacts the outer surface 35. The cutter 100 is moved along the wall 30 around the opening shape 37 to cut the wall 30 in the step 410 and form a plurality of tapered existing surfaces 38 in the outer surface 35 of the wall 30 adjacent to and surrounding the hole 32, as shown in FIG. 6A.

The tapered existing surfaces 38, as shown in FIGS. 6A and 6B, have a profile matching a half of the tapered profile 130 of the cutting surface 112; the half of the cutting surface 112 from the maximum radius 132 to the minimum radius 134. A slope of the tapered existing surfaces 38 is dictated by the taper angle α of the tapered profile 130. A maximum depth M of the tapered existing surface 38 that the cutter 100 cuts into the wall 30 from the outer surface 35, shown in FIG. 6B, is dictated by a difference between the maximum radius 132 and the minimum radius 134. The maximum depth M is at a portion of the tapered existing surfaces 38 positioned closest to the hole 32.

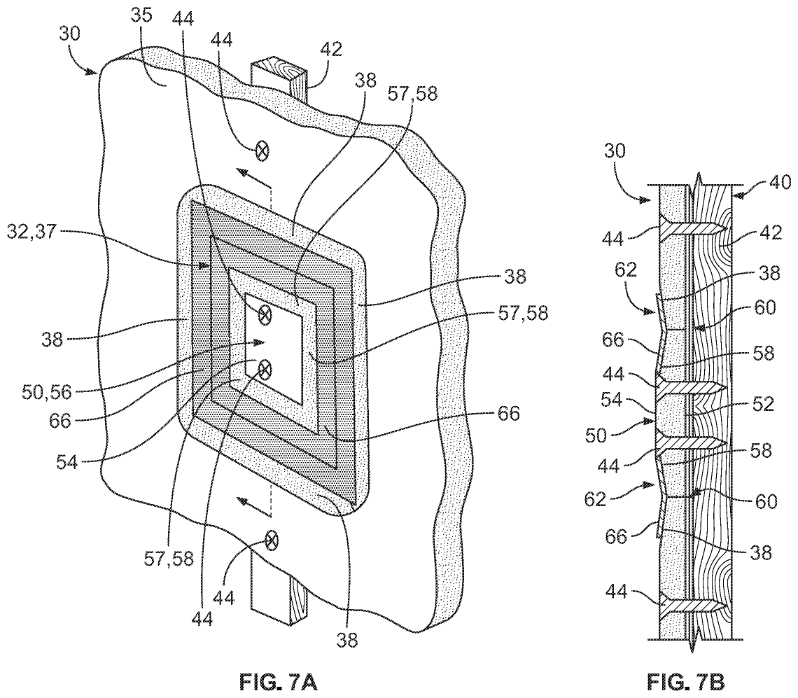

In a step 420 shown in FIG. 5, a repair section 50 shown in FIGS. 7A and 7B is provided. The repair section 50 is formed of a same material as the wall 30; the repair section 50 can likewise be a piece of drywall with the wall body 33 and the layers 34, or can be formed of a plaster material, a gypsum material, or any other type of material commonly used to form interior walls. The repair section 50 has an inner surface 52 and an outer surface 54 opposite the inner surface 52. The repair section 50 is formed in a repair shape 56 corresponding to the opening shape 37 of the hole 32. In the shown embodiment, the repair shape 56 is a square. In other embodiments, the repair shape 56 but can be any other type of regular, straight-sided or curved shape corresponding to the opening shape 37.

In a step 430 shown in FIG. 5, the repair section 50 is cut with the wall repair tool 10. As similarly described above for the cutting of the wall 30, the rotation input device 20 is actuated to rotate the cutter 100 and the cutter 100 is used to remove material around a perimeter 57 of the repair section 50, forming a plurality of tapered repair surfaces 58 in the repair section 50 extending along the perimeter 57.

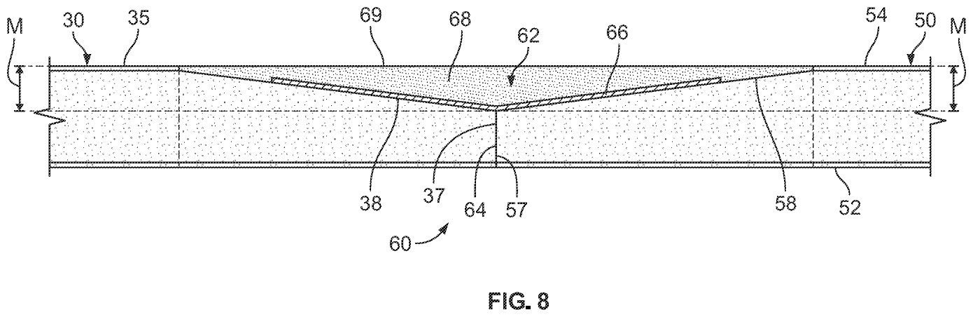

The tapered repair surfaces 58, as shown in FIGS. 7B and 8, have a profile matching a half of the tapered profile 130 of the cutting surface 112; the half of the cutting surface 112 from the maximum radius 132 to the minimum radius 134. A slope of the tapered repair surfaces 58 is dictated by the taper angle α of the tapered profile 130. A maximum depth M of the tapered repair surface 58 that the cutter 100 cuts into the repair section 50 from the outer surface 54, shown in FIG. 8, is dictated by a difference between the maximum radius 132 and the minimum radius 134. The maximum depth M is at an outermost portion of the tapered repair along the perimeter 57 of the repair section 50.

In a step 440 shown in FIG. 5, a support assembly 40 is positioned in the hole 32. The support assembly 40, as shown in FIGS. 6A and 6B, has a bracing 42 and a plurality of fasteners 44. The bracing 42 is an elongated piece of material, such as a strip of wood, that is inserted through the hole 32 and positioned against the inner surface 36 of the wall 30. The fasteners 44 extend through the wall 30 from the outer surface 35 to the inner surface 36 and hold the bracing 42 against the inner surface 36. In the shown embodiment, the fasteners 44 are each a screw, such as a drywall screw. In other embodiments, the fasteners 44 may be any other type of fastener capable of securing the bracing 42 to the material of the wall 30. The bracing 42 is positioned with a portion exposed in the hole 32 in the step 440.

In the embodiment of the repairing method 400 described above and shown in FIG. 5, the steps 420 and 430 related to the repair section 50 occur before the step 440 related to the support assembly 40. In another embodiment, the support assembly 40 can be positioned in the hole 32 prior to the providing and cutting of the repair section 50.

In a step 450 shown in FIG. 5, the repair section 50 is secured in the hole 32 in the position as shown in FIGS. 7A and 7B with the inner surface 52 of the repair section 50 against the bracing 42. The repair shape 56 of the repair section 50 corresponds with the opening shape 37 of the hole 32. The fasteners 44 are positioned to extend through the repair section 50 and engage the bracing 42, securing the repair section 50 in the hole 32.

As a result of the positioning in the step 450, as shown in FIGS. 7B and 8, the tapered existing surfaces 38 and the tapered repair surfaces 58 and form a valley 62 at a joint 60 between the tapered existing surfaces 38 and the tapered repair surfaces 58. The joint 60 has a seam 64 where the existing portion of the wall 30 abuts the repair section 50. The valley 62 is deepest adjacent to the seam 64, corresponding to the maximum depth M of the tapered existing surface 38 and the tapered repair surface 58, and becomes progressively shallower due to the slope of the tapered existing surface 38 and the tapered repair surface 58 further from the seam 64. In the shown embodiment, the tapered existing surface 38 and the tapered repair surface 58 are mirrored with respect to one another about the seam 64.

In the embodiment of the repairing method 400 described above and shown in FIG. 5, the wall 30 and the repair section 50 are each separately cut with the wall repair tool 10 to form the tapered existing surfaces 38 and the tapered repair surfaces 58 prior to securing the repair section 50 in the hole 32. In another embodiment, the repair section 50 can be positioned and secured in the hole 32 in the step 450 prior to forming the tapered existing surfaces 38 and the tapered repair surfaces 58. In this embodiment, the wall repair tool 10 can be used to cut the tapered existing surfaces 38 and the tapered repair surfaces 58 simultaneously with entire tapered profile 130 of the cutting surface 112, forming the valley 62 in a single cutting step.

In a step 460 shown in FIG. 5, the seam 64 is covered with a joint tape 66, as shown in FIGS. 7A, 7B, and 8. The joint tape 66 may be any type of thin, adhesive-backed material commonly used to cover seams between interior walls. The joint tape 66 is positioned over the seam 64 and extends along each of the tapered existing surface 38 and the tapered repair surface 58. The joint tape 66 does not extend beyond either the tapered existing surface 38 or the tapered repair surface 58 and is entirely positioned in the valley 62 in the shown embodiment. A result of the step 460 is shown in FIGS. 7A and 7B.

In a step 470 shown in FIG. 5, the valley 62 is filled with a joint compound 68 as shown in FIG. 8. The joint compound 68 may be any type of curable, tacky material commonly used with interior walls that is applied to the wall in a paste-like form and cures to a hard state. The joint compound 68 is filled in the valley 62 over the joint tape 66 in the paste-like form. The cured joint compound 68 has a shape corresponding to the shape of the valley 62; a triangular shape in the shown embodiment.

When cured, an outer surface 69 of the joint compound 68 opposite the joint tape 66 is approximately level with the outer surface 54 of the repair section 50 and the outer surface 35 of the wall 30, as shown in FIG. 8. In a step 480 shown in FIG. 5, the cured joint compound 68 can be sanded to smooth the outer surface 69 of the joint compound 68 with respect to the outer surfaces 35, 54. As shown in the process 400 of FIG. 5, the filling of the joint compound 68 in the step 470 and the sanding of the cured compound 68 in the step 480 can be repeated as many times as necessary to create an aesthetically unnoticeable repair of the hole 32.

The wall repair tool 10 according to the invention, by cutting the tapered existing surfaces 38 and the tapered repair surfaces 58, forms the valley 62 in which the joint tape 66 and the joint compound 68 are disposed. The valley 62 allows the joint tape 66 and at least a majority of the joint compound 68 to be disposed at or within the outer surfaces 35, 54. The joint compound 68 does not protrude far beyond the outer surfaces 35, 54 or the tapered surfaces 38, 58 at the seam 64 and can cover the joint tape 66 and the seam 64 without needing to be smoothed out over a large area. The concentrated application of the joint compound 68 in the valley 62 avoids the unneveness issues associated with larger spreads of compounds and requires less joint compound 68 to cover the seam 130, resulting in less cost, faster application of the joint compound 68, and faster drying times.

What is claimed is:

1. A wall repair tool, comprising:
a cutter rotatable about a cutter axis and having a cutter body with a cutting surface, the cutter body having a central section and a pair of end sections disposed on opposite sides of the central section, the cutting surface has a first cutting texture in the central section and a second cutting texture different than the first cutting texture in the end sections.

2. The wall repair tool of claim 1, wherein the first cutting texture is a rasp cutting texture and the second cutting texture is a fluted cutting texture.

3. The wall repair tool of claim 1, wherein the cutter body has a tapered profile with a maximum radius centrally along the cutter axis in the central section and a minimum radius in each of the end sections at a pair of opposite ends of the cutter body distal from the maximum radius.

4. The wall repair tool of claim 3, wherein the cutting surface extends linearly from the maximum radius to the minimum radius.

5. The wall repair tool of claim 1, further comprising a drive adapter having a main drive shaft connected to the cutter, rotation of the main drive shaft about a main drive shaft axis rotates the cutter about the cutter axis.

6. The wall repair tool of claim 5, wherein the cutter axis is offset from the main drive shaft in a depth direction perpendicular to the cutter axis and in a longitudinal direction perpendicular to the cutter axis and the depth direction.

7. The wall repair tool of claim 5, wherein the drive adapter has a frame with a base, a pair of arms extending from a first base side of the base, and a collar extending from a second base side of the base, the cutter is held by the arms and is rotatable with respect to the frame about the cutter axis.

8. The wall repair tool of claim 7, wherein the arms extend at an angle with respect to the collar.

9. The wall repair tool of claim 7, wherein the drive adapter has a bevel gear set connecting the main drive shaft to a device drive shaft extending perpendicular to the main drive shaft.

10. The wall repair tool of claim 9, wherein the collar releasably receives a rotational input device capable of driving rotation of the cutter via the device drive shaft.

11. The wall repair tool of claim 9, wherein the cutter, the bevel gear set, and the main drive shaft are disposed in a gear receiving space of the frame defined by the base and the arms.

12. The wall repair tool of claim 11, wherein the drive adapter has a gear shield disposed in the gear receiving space between the cutter and the bevel gear set.

13. The wall repair tool of claim 7, wherein the main drive shaft has a drive gear, the cutter has a cutter shaft extending through the cutter body, the cutter shaft has a cutter gear meshed with the drive gear.

14. The wall repair tool of claim 13, wherein the cutter gear and the drive gear are disposed outside of the arms.

15. The wall repair tool of claim 5, further comprising a housing having a housing body disposed around the cutter and the drive adapter.

16. The wall repair tool of claim 15, wherein the housing has a guard assembly attached to the housing body, the guard assembly has a cutter guard biased into a position extending beyond a cutting end of the housing body by a guard spring.

17. The wall repair tool of claim 16, wherein the cutter guard is movable against the guard spring to cover or expose the cutter beyond the cutting end of the housing body.

18. The wall repair tool of claim 15, wherein the housing body has a port extending through the housing body.

19. The wall repair tool of claim 10, further comprising a housing having a housing body disposed around the cutter and the drive adapter, an attachment end of the housing body abuts the rotational input device.

20. A method for repairing an existing portion of a wall having a hole, comprising:
providing a wall repair tool including a cutter rotatable about a cutter axis and having a cutter body, the cutter body has a central section and a pair of end sections disposed on opposite sides of the central section, the cutter body has a tapered profile with a maximum radius centrally along the cutter axis in the central section and a minimum radius in each of the end sections at a pair of opposite ends of the cutter body distal from the maximum radius;
cutting the wall around the hole with the wall repair tool to form a tapered existing surface adjacent to the hole;
providing a repair section having a repair shape corresponding to an opening shape of the hole;
cutting the repair section with the wall repair tool to form a tapered repair surface on a perimeter of the repair section; and
securing the repair section in the hole, the tapered existing surface and the tapered repair surface forming a valley at a joint between the tapered existing surface and the tapered repair surface.

21. The method of claim 20, further comprising covering a seam between the existing portion of the wall and the repair section with a joint tape disposed over the tapered existing surface and the tapered repair surface in the valley.

22. The method of claim 20, further comprising filling the valley with a joint compound.

23. The method of claim 22, further comprising sanding the joint compound and re-filling the valley with the joint compound.

24. The method of claim 20, wherein the existing portion of the wall and the repair section are formed of a same material.

25. The method of claim 20, wherein the cutter removes a material of the existing portion of the wall to form the tapered existing surface and/or the cutter removes a material of the repair section to form the tapered repair surface.

26. The method of claim 20, further comprising positioning a support assembly in the hole prior to the securing step.

27. The method of claim 26, wherein the support assembly includes a bracing fastened to an inner surface of the existing portion of the wall opposite an outer surface of the existing portion of the wall in which the tapered existing surface is disposed.
